(19) United States
(12) Patent Application Publication
(10) Pub. No.: US 2002/0178629 A1
(43) Pub. Date: Dec. 5, 2002

(54) Adverturf

(76) Inventor: James Arthur Dewberry JR., Huntersville, NC (US)

Correspondence Address: James A. Dewberry, 211 Black Kettle Lane, Alpharetta, GA, 30022, US

(21) Appl. No.: 09/870,895

(22) Filed: May 31, 2001

(51) Int. Cl. G09F 7/02

(52) U.S. Cl. 40/611

(57) ABSTRACT

This invention relates to an improved golf ball holder system. The invention is used for displaying advertisements while holding golf balls. The unit is placed on a golf course or golf center including but not limited to where the golfers warm-up or practice. The unit serves a dual purpose in holding the golf balls and as a venue for advertisements to be viewed by the golfer. The unit has a section that holds golf balls along with spaces for advertisements to be displayed on the surface of the unit. The unit has indentations in the surface to enable a person to be able to change the advertising signs/plaques easily. Also, the unit has a curved slope that allows the golf balls to be easily extracted from the ball holder. The unit's face is slanted at an angle so that the advertisements can be viewed easily by the golfer.

### DESCRIPTION

### FIELD OF THE INVENTION

This invention relates to the displaying of advertising indicia on golf courses and golf centers.

### BACKGROUND OF THE INVENTION

Golf courses and Golf centers have areas that golfers use to warm-up and to practice their golf swings. Golfers hit golf balls on these areas before they play and when they want to practice their swing; they are supplied with golf balls, which they in turn hit into a large open area. Often it is desirable for the golf course or golf center to have predetermined sections and ball trays already out for the golfers to use and to keep them separated from one another. Typically the golf centers and courses use lengths of rope to divide the area where they want the golfers to stand and they use plastic ball trays to keep the golf balls in one area. Golf centers also provide golf mats and plastic ball trays for golfers to hit off of to save the grass and make a better surface to practice from.

### SUMMARY OF THE INVENTION

The invention makes it easier for golf courses and golf centers to achieve the tasks mentioned above while providing a means to advertise to all of the golfers who come to their establishment. The invention allows for the golf courses and golf centers to separate the golfers and provide them a place to hold their golf balls. The units are placed on the ground and are about (5) feet in length. Since the units are plastic and easily moved they can be used on any surface to separate the golfers and hold golf balls while allowing signs/plaques to be placed on the unit that are always in plain view of the golfer while he/she is hitting golf balls.

What is claimed is:

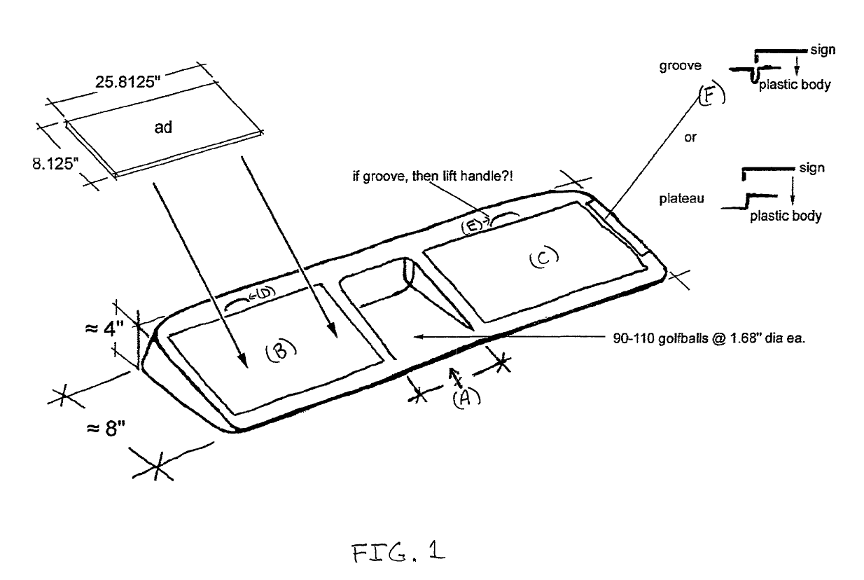

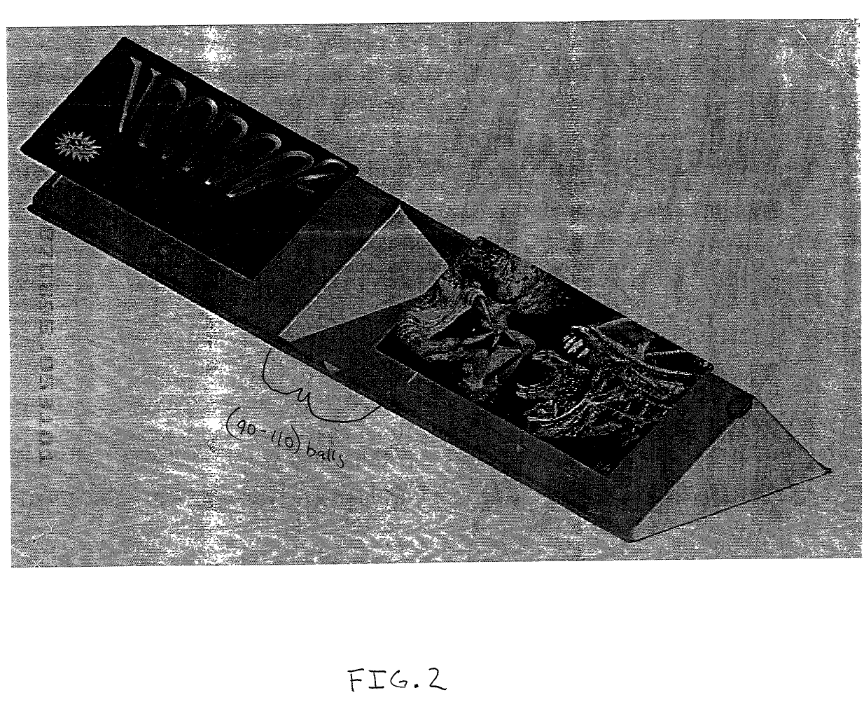

1. A golf ball holder system comprising:
FIG. 1 A base unit that has predetermined areas in which to hold advertising indicia and a predetermined area to hold golf balls.
1-a) The golf ball holder system claim 1a, further comprising a predetermined area in which to hold golf balls.
1-b) The golf ball holder system claim 1b, specific area in which to hold advertising indicia or instructional literature.
1-c) The golf ball holder system claim 1c, specific area in which to hold advertising indicia or instructional literature.
1-d) The golf ball holder system claim 1d, unit includes indentations that allow the advertising indicia or instructional literature to be removed easily.
1-e) The golf ball holder system claim 1e, unit includes indentations that allow the
1-f) The golf ball holder system claim 1f, unit includes a specific area that will allow for extra clubs, equipment, or drinks to be stored on the unit.
